(19) United States
(12) Patent Application Publication
(10) Pub. No.: US 2018/0012001 A1
(43) Pub. Date: Jan. 11, 2018

(54) MOBILE DEVICE SECURITY SYSTEMS AND METHODS

(71) Applicant: Redfrog Security, LLC, Eden Prairie, MN (US)

(72) Inventors: William Wallus, Prior Lake, MN (US); Brandon Dols, Minneapolis, MN (US)

(21) Appl. No.: 15/644,324

(22) Filed: Jul. 7, 2017

Related U.S. Application Data
(60) Provisional application No. 62/359,404, filed on Jul. 7, 2016.

(51) Int. Cl. G06F 21/31; G06F 9/445

(52) U.S. Cl. CPC G06F 21/31; G06F 8/61

(57) ABSTRACT

A system and method for securing a mobile device may include providing software for installation on the mobile device where the software is configured for disabling at least some functionality of the device, storing a mobile device identifier identifying the mobile device, and determining an unlock code for unlocking the mobile device, receiving a notification of sale of the mobile device, and providing the unlock code. Systems and methods for receiving and verifying the unlock code are also described.

### FIELD OF THE INVENTION

The present invention relates to novel and advantageous systems and methods for mobile device security. More particularly, the present invention relates to systems and methods for enabling a mobile device for use after a point of sale transaction.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Mobile devices such as cellular phones, for example, are commonly sold in retail stores or other retail settings. They may be sold with a service plan, such as a cellular phone plan, data plan, text messaging plan, or other mobile device service plan, as a service included device (post paid). A mobile device may alternatively be sold with a pre-paid or unlocked phone plan. Mobile devices may often be targets for theft, particularly where a mobile device may be sold with a pre-paid or unlocked plan. To deter or decrease theft, retail stores often use various security procedures to protect mobile devices. For example, some retail stores may place mobile devices for sale behind or within a glass or plastic case that may be locked. As another example, retail stores may place mobile devices in individual plastic cases that may be unlocked by a store employee at the point of sale.

There is a need in the art for systems and methods for securing a mobile device so as to deter or reduce theft. Specifically, there is a need in the art for systems and methods for securing a mobile device such that a consumer may unlock the device during or after a point of sale transaction.

### BRIEF DESCRIPTION OF THE DRAWINGS

In the accompanying drawings, reference characters refer to the same parts throughout the different figures. The drawings are not necessarily to scale, emphasis has instead been placed upon illustrating the principles of embodiments of the present disclosure. With respect to the drawings:

FIG. 1 is a schematic diagram of a system according to one or more embodiments.

FIG. 2 is a flow diagram of a method performable by a system of the present disclosure, according to one or more embodiments.

FIG. 3 is a flow diagram of a method performable by a mobile device of the present disclosure, according to one or more embodiments.

FIG. 4A is a flow diagram of a method of activating a mobile device, according to one or more embodiments.

FIG. 4B is a flow diagram of an activation path of the present disclosure, according to one or more embodiments.

FIG. 4C is a flow diagram of another activation path of the present disclosure, according to one or more embodiments.

### DETAILED DESCRIPTION

The present disclosure relates to systems and methods for mobile device security. Particularly, the systems and methods of the present disclosure relate to securing or locking a mobile device prior to sale, such that at least some of the functionality of the mobile device may be unusable until the device is unlocked. In some embodiments, the mobile device may be locked during the boot process or software initialization process of the device, such that other programs, applications, operating systems, and other functionality may remain disabled or non-functional until the device is successfully unlocked. Further, in some embodiments, one or more secure codes may be entered on the device or at a different user interface in order to unlock the phone. In some embodiments, one or more secure codes may be generated based on, or may relate to, an indication that the mobile device has been legitimately purchased.

Generally, various systems and methods may be employed by retailers and manufacturers in deterring product theft or fraud. In some embodiments, an activation procedure may be used to unlock or activate a product during or after purchase. In this way, when the product is locked, or not activated, the product may be unusable. An unusable product may deter or reduce theft or fraud. For example, pre-loaded gift cards or other gift cards sold by retailers may be unusable for making purchases until activated. In some embodiments, a database storing identifiers for a plurality of gift cards may be maintained locally or remotely from a point-of-sale (POS) of a retailer. The identifier for a gift card may be, for example, the barcode or other number located on and/or associated with the gift card. The database may store identifiers for unactivated gift cards, activated gift cards, or both. The database may be in communication with the retailer POS over a wired or wireless network, such that when a gift card is scanned or otherwise registers as being sold at the POS, the POS may ping or notify the database of the sale. Once the database is updated, or a record of the sold gift card is otherwise made, the gift card may be activated. When a purchaser attempts to use a gift card to make purchases, the gift card may only function to complete the purchase if it has been activated. If the gift card is not activated, the gift card may be unusable for making purchases.

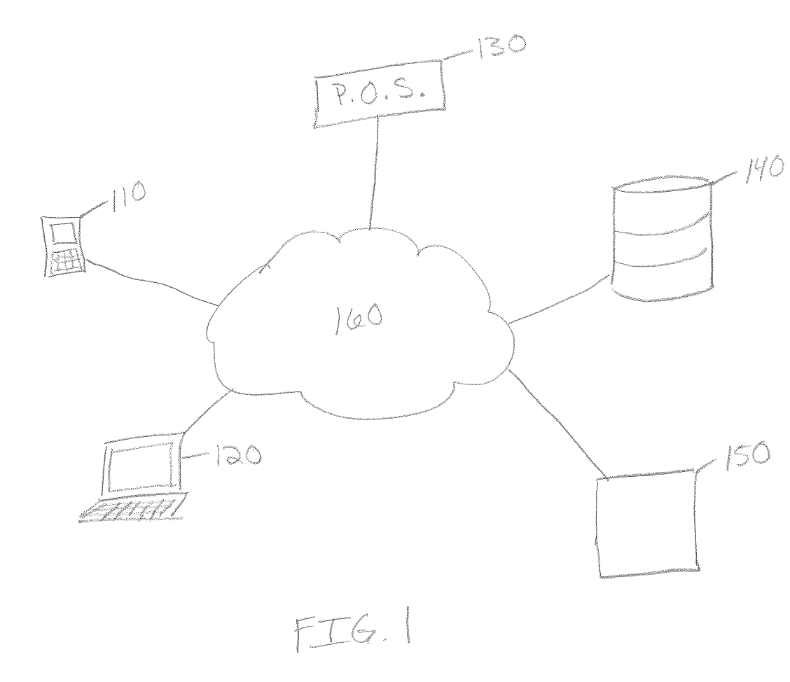

Referring now to FIG. 1, a system for mobile device security 100 may include a mobile device 110, a user interface, 120, a retailer POS 130, a database 140, and a processor 150 in communication over a wired or wireless network 160.

The mobile device 110 may be a mobile computing device such as a mobile phone, smartphone, PDA, tablet, smart watch, fitness tracking device, or other mobile device. The mobile device 110 may generally be a device configured to connect to a mobile network. The mobile device 110 may be associated with one or more identifiers, such as but not limited to a stock keeping unit (SKU) number, universal product code (UPC) number, international mobile equipment identity (IMEI) number, and/or retailer identifier. The one or more identifiers may be provided by a manufacturer, retailer, or other entity. In some embodiments, the system 100 may include a plurality of mobile devices 110, each having one or more identifiers. The mobile device 110 may have software, such as an operating system, applications, and other software. In some embodiments, the mobile device 110 may have initialization software such as bootloader or similar startup software. In conjunction with the bootloader software, the mobile device 110 may have lockdown software. The lockdown software may operate to disable at least some functionality of the mobile device until an unlocking procedure is performed.

With continued reference to FIG. 1, the system 100 may include a user interface 120. The user interface 120 may be a computing device such as a desktop computer, notebook computer, tablet, PDA, mobile phone, smartphone, or other computing device.

The system 100 may have a retailer POS 130. The POS 130 may include a computing device. The POS 130 may be configured for scanning or inputting a mobile device identifier, such as a SKU number, UPC number, IMEI number, and/or retailer identifier. The identifier may be scanned or input as part of the sale when a mobile device is purchased, in some embodiments. In some embodiments, the POS 130 may be configured to send sales and/or customer information to the database 140 and/or processor 150.

The system 100 may include a database 140 in some embodiments. The database 140 may store, as computer readable storage media, one or more identifiers related to the mobile device 110. For example, the database 140 may store a SKU number, UPC number, IMEI number, and/or retailer identifier. In some embodiments, where the system 100 includes a plurality of mobile devices 110, the database 140 may store one or more identifiers for each mobile device of the system. The device identifiers stored in the database may be provided by a manufacturer. In some embodiments, the database 140 or one or more additional databases may store sales information and/or customer information. Particularly, in some embodiments, the database 140 may store information related to the sale of a mobile device. For example, when a mobile device is sold, the database 140 may associate the sale date, time, location, or other information with the one or more identifiers associated with the mobile device. The database 140 may store customer contact information for the purchaser of the mobile device in some embodiments.

With continued reference to FIG. 1, the system 100 may include a processor 150. The processor 150 may include hardware, software, and/or an application program interface (API), and in some embodiments may be configured for receiving information from the POS 130, user interface 120, and/or mobile device 110. For example, in some embodiments, the processor 150 may receive a notification of sale from the POS 130 for a sale of the mobile device 110. The processor 150 may have an algorithm for determining an unlock code for a mobile device. An unlock code may be a code unique to a particular mobile device in some embodiments. In some embodiments, the unlock code for a mobile device may relate to the SKU, UPC, IMEI, retailer identifier, or other identifier for the mobile device. The unlock code for a mobile device may allow the device to be unlocked, and thereby made generally operational or functional during or after purchase.

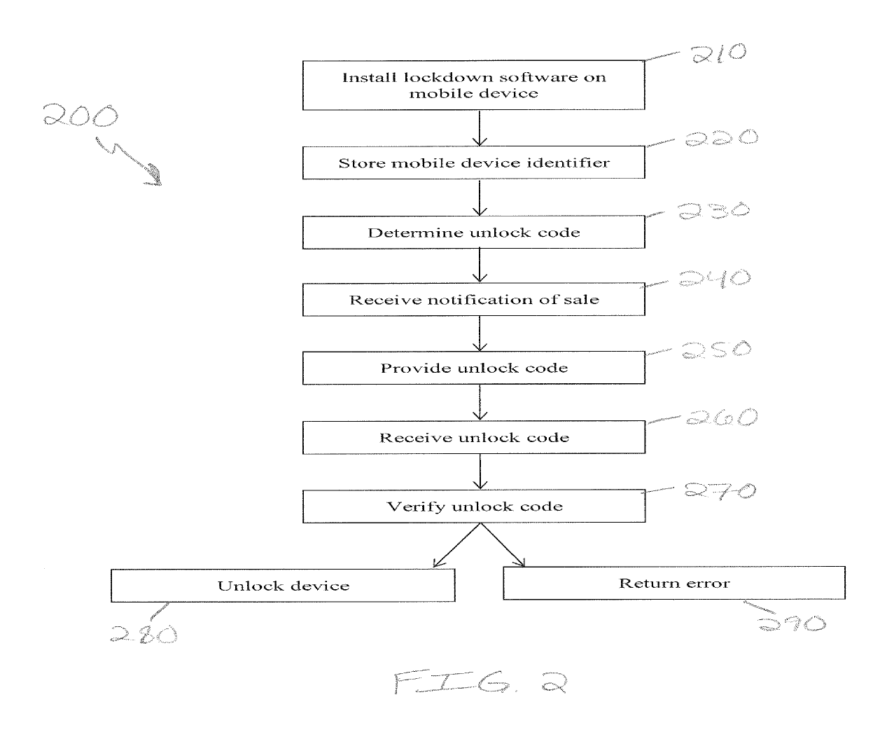

One or more systems of the present disclosure may perform, or facilitate the performance of, one or more methods. For example, one or more systems of the present disclosure may perform, or facilitate the performance of, method 200 shown in FIG. 2. The method 200 may include the steps of installing lockdown software on a mobile device 210, storing an identifier for the mobile device 220, determining an unlock code 230, receiving a notification that the mobile device was purchased 240, providing the unlock code 250, receiving an unlock code 260, verifying the unlock code 270, and unlocking the mobile device 280 or returning an error 290.

As shown in FIG. 2, the method 200 may include installing lockdown software on a mobile device 210. The lockdown software may be an application or other program or code that operates in conjunction with bootloader software on the mobile device. That is, the lockdown software may generally operate behind an operating system of the device or without an operating system. The lockdown software may generally disable or temporarily delay at least some functionality of the mobile device. For example, in some embodiments, the lockdown software may temporarily disable USB functionality and SD or SIMM card functionality of the mobile device. The lockdown software may prevent the operating system from loading or initializing on the device. The lockdown software may additionally or alternatively temporarily disable particular key functions and any boot override functions. The lockdown software may prevent a user from making or receiving phone calls, accessing a web browser, sending or receiving messages, and other functionality. However, it may be appreciated that the lockdown software may allow some functionality of the mobile device. For example, the lockdown software may allow access to emergency services such as phone calls or text messages sent to police, 9-1-1 operators, or other emergency contacts, or may allow for Internet or broadband access, such that the device may send and receive particular communications related to the unlock procedure. The lockdown software may also allow particular key or button functionality of the device.

The method 200 may include storing an identifier for the mobile device 220. As described above, an identifier for the mobile device may be a SKU number, UPC number, IMEI number, retailer identifier, or other identifier unique to the mobile device. The identifier may be stored in a database, for example, along with identifiers for a plurality of mobile devices. Storing the identifier may provide for a record of particular mobile devices that are available for sale at a point in time. In some embodiments, the identifier may be stored by a manufacturer, retailer, or other entity. For example, in some embodiments, where a manufacturer provides mobile devices to a retailer for sale, the manufacturer may additionally provide the retailer or another entity with a digital file of device identifiers identifying the devices to be sold.

The method 200 may additionally include determining an unlock code 230. The unlock code may be a code unique to the mobile device that allows the mobile device to be unlocked, activated, or enabled for use, such as after purchase for example. In some embodiments, the unlock code may be based on an identifier for the mobile device, such as an IMEI number for example. The unlock code may be calculated based on an algorithm. In some embodiments, for example, the unlock code may be a hexadecimal or other alphanumeric translation of the IMEI number. Other algorithms may be used to calculate the unlock code for the mobile device in other embodiments. In some embodiments, the unlock code may be separated into more than one portion such that a user may enter a first portion of the unlock code and a second portion of the unlock code at different stages of the unlock procedure, for example.

The method 200 may include receiving a notification that the device was purchased 240. In some embodiments, the notification may be sent by a retailer, for example at a POS. The notification may be sent upon scanning or inputting the mobile device identifier at the POS. The notification of sale may include particular information about the sale and/or purchaser in some embodiments. For example, the notification may include a date, time, and location of the sale. In some embodiments, the notification may additionally or alternatively include contact information of the purchaser of the mobile device. Such information may be stored with the mobile device identifier in the database, as described above. The notification may be sent automatically upon sale in some embodiments. In other embodiments, the notification may be sent by some user input. For example, a sales associate at the POS may manually send the notification in some embodiments.

The method 200 may include providing the unlock code 250. The unlock code may be provided to a purchaser, user, or retailer. The unlock code may be provided over the mobile device, a user interface, or the POS in some embodiments. For example, the unlock code may be displayed on a screen of the device, interface, or POS for a user, retailer, or purchaser to view. In other embodiments, the unlock code may be provided by other means. For example, the unlock code may be provided via phone call, text message, email, or other communication. In other embodiments, the unlock code may be provided over a website. The user, purchaser, or retailer may visit the website to retrieve the unlock code. In some embodiments, the user, retailer, or purchaser may be prompted to provide information about the sale and/or purchaser, user, or retailer prior to receiving the unlock code. In still further embodiments, the unlock code may be printed on the sales receipt provided to the purchaser after purchasing the mobile device. In other embodiments, the unlock code may be provided in information packaged with the mobile device.

The method 200 may further include receiving an unlock code 260. The unlock code may be received via the purchased mobile device, from the POS, from a different user interface, or from another source. The unlock code may be received from a purchaser, user, or retailer. Generally, it may be appreciated that the unlock code may be provided to a user, purchaser, or retailer by different means than it is received. For example, an unlock code may be provided (250) to a POS, but may be received (260) from a user interface or from the mobile device. In other embodiments, an unlock code may be provided to the mobile device, but may be received from the POS or a user interface.

It may be appreciated that in some embodiments, an unlock code may be provided (250) and received (260) in more than one portion. For example, in some embodiments, a first portion of the unlock code may be provided and received, and a second portion of the unlock code may be provided and received. In some embodiments, the first portion of the unlock code may be provided via the mobile device and received from a user interface or POS. In some embodiments, a second portion of the unlock code may be provided via a user interface or POS and received from the mobile device. In other embodiments, the first portion, second portion, or other portions of the unlock code may be provided by and/or received from different sources.

The method 200 may include verifying the unlock code 270. Verifying the unlock code may include verifying a first portion, second portion, or any other portion of the unlock code. Where a first portion and second portion of the unlock code are provided and received individually, as described above, each portion may be verified after it is received. For example the first portion may be verified before providing the second portion. The unlock code may be verified by comparison to an expected, predetermined, stored, or calculated unlock code for the particular mobile device in some embodiments. Other methods of verifying an unlock code may be used in other embodiments. As shown in FIG. 2, if the unlock code is verified, the mobile device may be unlocked 280. That is, functionality of the device that may have been disabled or delayed by the locking software may be permitted. However, if the unlock code is not verified, an error or other message may be returned 290. The error message may be displayed at the retail POS, purchased mobile device, or other interface. The error message may notify the purchaser or retail associate that the mobile device may not be unlocked due to an incorrect unlock code. Additionally or alternatively, where the unlock code is not verified at step 270, the method 200 may include additional steps such as providing an option to retry the verification, automatically retrying the verification, automatically or providing an option for reentering the unlock code, displaying a help or customer service number, automatically placing a call or sending a message to a help or customer service center, or displaying or providing other instructions or options.

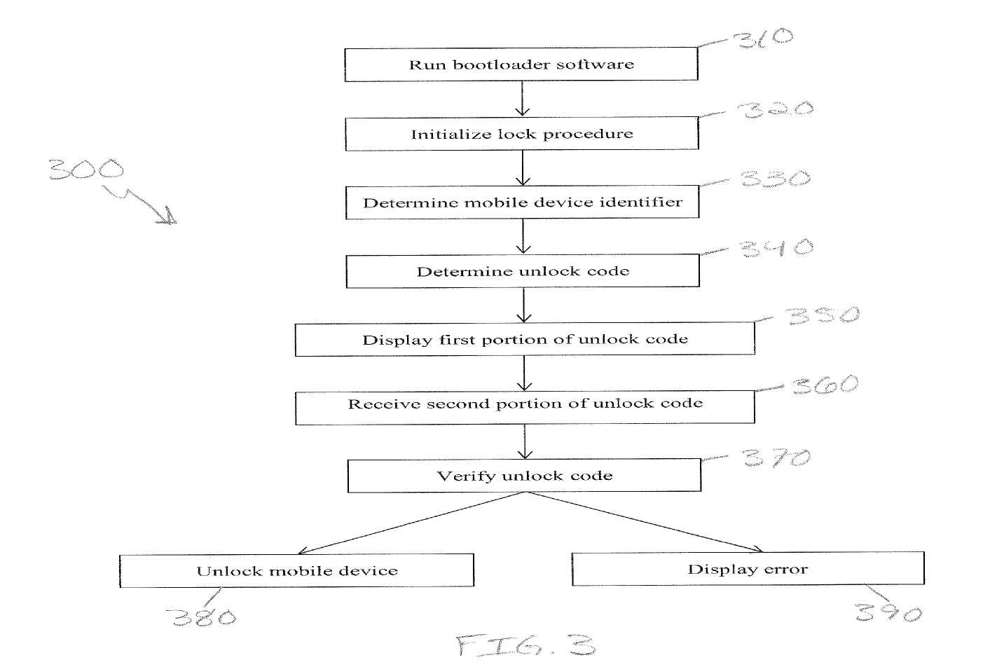

The mobile device may perform one or more methods. The method 300, as shown in FIG. 3 may include running the bootloader software 310, initializing the lock procedure 320, determining an identifier for the mobile device 330, determining an unlock code 340, displaying a first portion of the unlock code 350, receiving a second portion of the unlock code 360, verifying the unlock code 370, and unlocking the mobile device 380 or displaying an error 390. In some embodiments, the method 300 may be performed upon first powering on the mobile device after or during purchase. In other embodiments, the method 300 may be performed at any suitable time.

The method may include running bootloader or other initialization software 310. The bootloader or other initialization software may be a program that operates prior to an operating system or other programs or applications on the mobile device. The bootloader or other initialization software may initialize the lock procedure 320. The lock procedure may be performed by disabling or limiting at least some functionality of the mobile device. For example, USB, SD card, and SIM card functionality of the mobile device may be temporarily disabled in some embodiments. In some embodiments, the mobile phone may be temporarily restricted from sending or receiving calls or messages or accessing an Internet browser or other applications. In some embodiments, some capabilities of the mobile device may be maintained. For example, some Internet or broadband capabilities may be maintained such that the device can send and receive particular communications during the unlocking process.

The method 300 may include determining an identifier for the mobile device 330. As described above, an identifier may be a SKU number, UPC number, IMEI number, retailer identifier, or other identifier. The identifier may be determined by searching the device. In some embodiments, the mobile device may automatically search its internal data to determine an identifier. In other embodiments, the identifier may be determined by sending a request to a database containing mobile device identifiers. The device may automatically send a request for a mobile identifier in some embodiments.

The method 300 may include determining an unlock code 340. The unlock code may be determined by searching the device. In some embodiments, the mobile device may automatically search its internal data to determine an unlock code. In other embodiments, the mobile device may calculate an unlock code. For example, an algorithm may determine an unlock code based on the mobile device identifier. As described above, a hexadecimal or other system may be used to convert the device identifier to an unlock code in some embodiments. In other embodiments, the unlock code may be determined by sending a request to a database containing unlock codes. The device may automatically send a request for an unlock code in some embodiments.

In some embodiments, the method may include displaying a first portion of the unlock code 350. The first portion of the unlock code may be displayed on a screen of the mobile device, viewable by a user or purchaser, for example. In some embodiments, a different portion or all portions of the unlock code may be displayed on the mobile device. The first portion of the unlock code may be displayed such that a user or purchaser may use the first portion, such as by inputting it into a different interface. As described above, the user or purchaser may input the first portion at a POS or user interface.

The method 300 may include receiving a second portion of the unlock code 360. The second portion may be received from a user or purchaser inputting the second portion into the mobile device, via a keyboard for example. In other embodiments, the second portion may be received from another source. In some embodiments, a different portion or all portions of the unlock code may be received by the mobile device.

In some embodiments, the method 300 may include verifying the unlock code 370. Verifying the unlock code may include verifying the second portion received in step 360, in some embodiments. In other embodiments, verifying the unlock code may include verifying a different portion or all portions of the unlock code. Verifying the unlock code may include comparing the unlock code, or received portion of the unlock code, to an expected, stored, previously determined, or calculated unlock code. In other embodiments, verifying the unlock code may include sending the received unlock code, or portion of the unlock code, to a comparison module, verification module, or other component.

If the unlock code is verified in step 370, the method 300 may include unlocking the mobile device 380. Unlocking the mobile device may include enabling any functionality disabled or limited during the lock procedure initialized at step 320. However, if the unlock code is not verified in step 370, the method 300 may include displaying an error message 390. The error message may be displayed on a screen of the mobile device, so as to be viewable by a user or purchaser. Additionally or alternatively, where the unlock code is not verified at step 370, the method 300 may include additional steps such as providing an option to retry the verification, automatically retrying the verification, automatically or providing an option for reentering the unlock code, displaying a help or customer service number, automatically placing a call or sending a message to a help or customer service center, or displaying or providing other instructions or options.

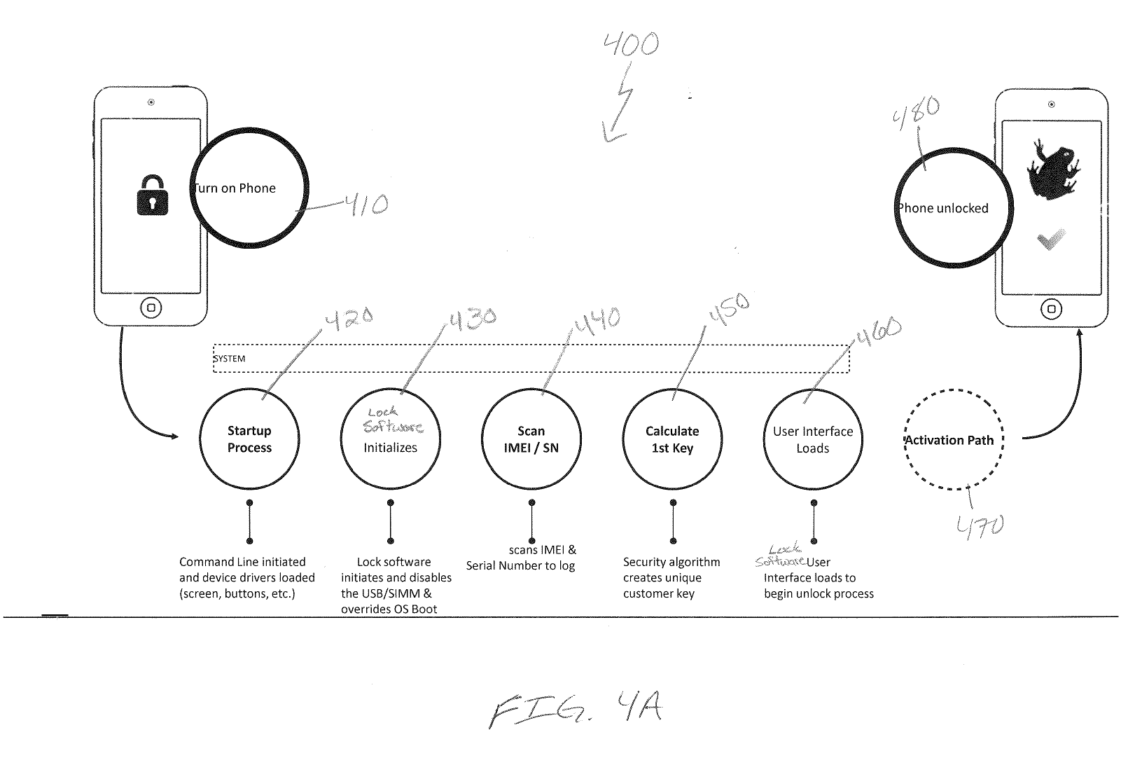

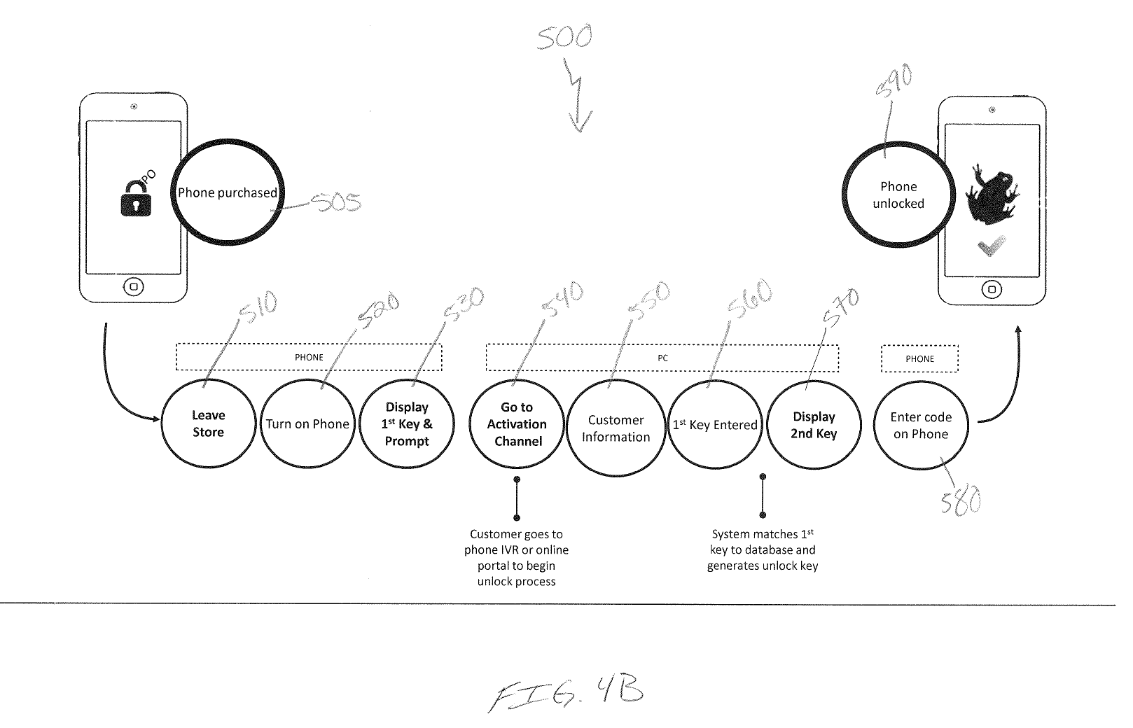

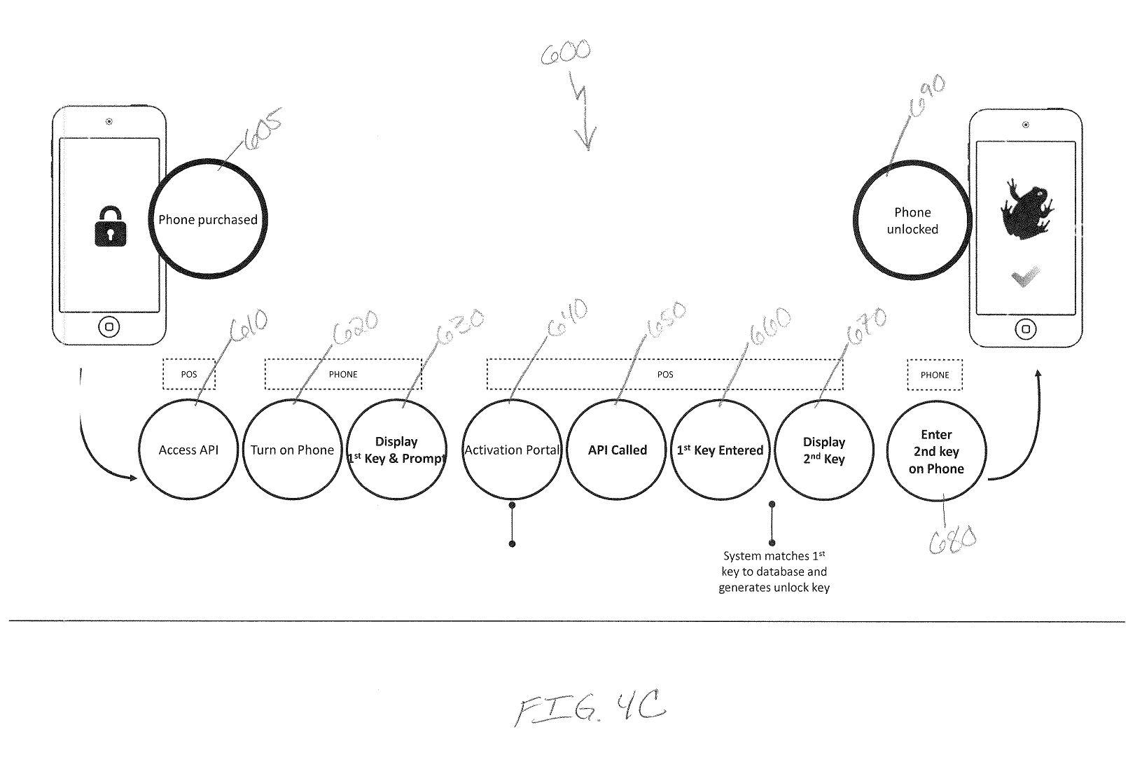

Turning now to FIG. 4A, a method 400 for activating a mobile device after purchase of the device is shown. As shown, the method 400 may include powering on the mobile device 410, running a startup process 420, initializing lockdown software 430, scanning an identifier 440, calculating a first unlock key 450, loading a user interface 460, completing an activation path 470, and unlocking the mobile device 480.

After purchase of a mobile device, such as a cellular phone or smartphone, the device may be powered on 410. This may be performed by a purchaser or by a sales associate at the POS, for example. Upon powering on, a startup process may be initiated on the device 420. The startup process may include initialization of a command line and loading of device drivers in some embodiments. Additionally, lockdown or lock software may initialize 430. Initialization of the lock software may cause USB drive, SIMM card, and other elements to become disabled or otherwise unusable. Initialization of the lock software may additionally override operating system software on the device. As described above, various capabilities and programs of the device may be disabled, while others, such as access to place emergency phone calls, particular Internet or broadband access, or other elements, may be permitted.

The method 400 may further include scanning an identifier 440, such as SKU number, UPC number, IMEI number, retailer identifier, or other identifier unique to the mobile device. The identifier may be scanned at a POS by a sales associate, for example. In other embodiments, the identifier may be entered at the POS or at a different device or provided or acquired by other means. In other embodiments, the identifier may be determined by sending a request to a database containing mobile device identifiers.

The method 400 may further include calculating a first unlock key 450. The first unlock key may, in some embodiments, relate to the device identifier. As described above, for example, the first unlock key may be or include a hexadecimal or other conversion of the device identifier. In other embodiments, the first unlock key may be determined by other means.

The method 400 may include loading a user interface on the mobile device 460. The user interface may be a component of the lock software in some embodiments. That is, for example, while particular capabilities of the device may be unusable and while the operating system may be overridden, a lock software interface may allow a user to interact with the device in order to complete the unlock process. Using the user interface, a user, such as a purchaser or sales associated for example, may initiate or complete an activation path 470 to unlock or otherwise enable the mobile device. Upon completion of the activation path, the device may be unlocked 480.

FIGS. 4B and 4C show examples of activation paths that may be completed to unlock the device. For example, FIG. 4B illustrates an activation path 500 that may be performed by or facilitated by a purchaser or other user after purchase of a mobile device. As shown, after the device is purchased 505 from a retailer, the purchaser may leave the retailer with the device 510. The purchaser may power on the device 520, and a first unlock key may be displayed on the device 530. As described above, the first unlock key may be a key calculated or determined based a unique identifier for the device in some embodiments. Additionally, as part of the activation path 500, a user such as the purchaser may interact with an activation channel 540 using a desktop computer, laptop computer, or other device. The activation channel may be a website or an application in some embodiments. For example, the purchaser may use a web accessible computer or device to visit an activation channel website in some embodiments. In other embodiments, the activation channel may be a call center or an interactive voice response (IVR). The purchaser may use the mobile device or a different device to call a phone number for the activation channel. It may be appreciated, that where the purchased mobile device is used to reach the activation channel, the lock software otherwise blocking particular functionality of the device may permit access to the activation channel. Via the activation channel, the purchaser may enter customer information 550. Customer information may include biographical information, purchase information, contact information, and/or other information. The purchaser may additionally enter the first unlock key, as displayed on the mobile device, via the activation channel 560. It may be determined whether the first unlock key as entered via the activation channel matches a stored first unlock key for the mobile device. Upon a correctly entered first unlock key, a second unlock key may be provided to the purchaser via the activation channel 570. The second unlock key may be calculated or determined based on the first unlock key and/or based on a unique identifier for the mobile device. After receiving the second unlock key from the activation channel, the purchaser may enter the second unlock key into the mobile device 580 and the mobile device may be unlocked 590.

FIG. 4C illustrates an activation path 600 that may be performed by or facilitated by a user such as a sales associate. As shown, after the device is purchased 605, a user such as a sales associate may access an application program interface (API) 610 via a desktop computer, laptop computer, or other device. Generally, where the user is a sales associate, the sales associate may access the API at the POS. The sales associate or purchaser may additionally power on the device 620. The device may display a first unlock key 630. With the first unlock key, the device may additionally prompt a user to enter a second unlock key. The sales associate or other user may access an activation portal 640. The activation portal may be accessed via a desktop computer, laptop computer, or other device at the POS in some embodiments. In some embodiments, the sales associate may access the API via the activation portal at the POS or another device. That is, the API may be called or accessed through the activation portal 650. In some embodiments, the API accessed via the activation portal may be the same as or similar to the portal accessible via an IVR or online portal, as discussed above with respect to FIG. 4B for example. The sales associate or other user may enter the first unlock key, as displayed on the mobile device, at the activation portal 660. It may be determined whether the first unlock key as entered matches a stored first unlock key for the mobile device. Upon a correctly entered first unlock key, a second unlock key may be provided to the sales associate or other user via the activation portal 670. The second unlock key may be calculated or determined based on the first unlock key and/or based on a unique identifier for the mobile device. After receiving the second unlock key from the activation portal, the sales associate or other user may enter the second unlock key into the mobile device 680 and the mobile device may be unlocked 690.

While some embodiments of the present disclosure have been described with respect to mobile devices purchased at physical retailer locations, it may be appreciated that embodiments of the present disclosure may be similarly applicable for mobile devices purchased on the Internet, through an application, or by other means. That is, embodiments of the present disclosure may apply with respect to online shopping cart procedures or other online purchase procedures, for example.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A method for securing a mobile device, comprising:
providing software for installation on the mobile device, the software being configured for disabling at least some functionality of the device;
storing a mobile device identifier identifying the mobile device;
determining an unlock code for unlocking the mobile device;
receiving a notification of sale of the mobile device; and
providing the unlock code.

2. The method of claim 1, wherein determining the unlock code incorporates an identifier for the mobile device.

3. The method of claim 2, wherein the identifier is an IMEI number.

4. The method of claim 1, wherein providing the unlock code comprises providing the unlock code to a user of the mobile device.

5. The method of claim 4, wherein providing the unlock code comprises sending a text message.

6. The method of claim 1, wherein receiving a notification of sale of the mobile device comprises receiving notification from a POS.

7. The method of claim 6, further comprising storing information from the notification in a database.

8. A method for executing preloaded software by a processor at the time of startup of a mobile device, the method comprising:
disabling an input function
disabling a storage function;
disabling a communication function;
preventing modification to the preloaded software;
selectively enabling internal software services;
read unique device identification information;
store an unlock code through a secure algorithm;
prevent normal startup of the operating system on the mobile device; and
prepare the device for user interaction.

9. The method of claim 8, wherein disabling an input function comprises disabling a USB port during start up.

10. The method of claim 8, wherein disabling a storage function comprises disabling sim card during start up.

11. The method of claim 10, wherein disabling a storage function comprises disabling an internal and/or external storage device during start up.

12. A system for implementing secure merchandising of mobile products, the method comprising:
a database storing a plurality of mobile product identifiers for respective mobile products;
a database of verification information relating to the mobile products and status to:
report status of sale of mobile device;
report status of shipping confirmation;
report status of disposition;
report status of display;
a processor configured for unlocking the mobile products by:
determining an unlock code for unlocking the mobile device;
providing the unlock code;
receiving the unlock code; and
verifying the unlock code.

13. The method of claim 12, wherein determining the unlock code incorporates an identifier for the mobile device.

14. The method of claim 13, wherein the identifier is an IMEI number.

15. The method of claim 12, wherein providing the unlock code comprises providing the unlock code to a user of the mobile device.

16. The method of claim 15, wherein providing the unlock code comprises sending a text message.

17. A secure mobile device, comprising:
a mobile device readable storage medium configured for storing information;
a processor configured for accessing the mobile device readable storage medium and performing processes based on the information;
a bootloader stored on the mobile device readable storage medium, operable by the processor, and configured to control startup operations;
an operating system stored on the mobile device readable storage medium and operable by the processor;
a lockdown module stored on the mobile device readable storage medium, operable by the processor, and configured to restrict operation of the mobile device unless the device is verified as available for use, the lockdown module configured to:
run at the time of startup of the mobile device and in conjunction with the operating system;
operate in conjunction with a bootloader module of the mobile device;
disable input functions to limit modification of the mobile device readable storage medium during startup;
facilitate unlocking of the mobile device upon successful authentication; and
provide user instructions and notifications.

18. The device of claim 17, wherein the lockdown module operates apart from the operating system.

19. The system of claim 18, wherein the lockdown module limits the functionality of the operating system.

20. The system of claim 17, wherein unlocking of the mobile device comprises receiving and verifying an unlock code.
